(19) United States
(12) Patent Application Publication
(10) Pub. No.: US 2025/0378043 A1
(43) Pub. Date: Dec. 11, 2025

(54) SYSTEM-ON-CHIP HAVING NON-VOLATILE MEMORY STORING A MACHINE LEARNING MODEL AND PERFORMING INFERENCE USING THE MODEL

(71) Applicant: Mercedes-Benz Group AG, Stuttgart (DE)

(72) Inventor: Francois Piednoel, Sunnyvale, CA (US)

(21) Appl. No.: 19/017,300

(22) Filed: Jan. 10, 2025

Related U.S. Application Data
(60) Provisional application No. 63/568,603, filed on Mar. 22, 2024.

(51) Int. Cl. G06F 15/78

(52) U.S. Cl. CPC G06F 15/7814; G06F 15/7821

(57) ABSTRACT

A computing device, such as a system-on-chip, can include non-volatile memory and volatile memory. The computing device can further include processing resources that read a set of values of the ML model and apply the set of values of the ML model to input data. Based on applying the set of values to the input data, the processing resources can determine regions of the ML model having fixed values and regions of the ML model having non-fixed values. Upon making this determination, the processing resources can migrate or store the regions of the ML model having non-fixed values in the volatile memory of the computing device.

### CROSS-REFERENCE TO RELATED APPLICATION

This application claims the benefit of priority to U.S. Provisional Application No. 63/658,603, filed on Mar. 22, 2024, which is hereby incorporated by reference in its entirety.

### BACKGROUND

Flash memory is a type of non-volatile memory that can be electronically erased and reprogrammed, and is typically used in Universal Serial Bus (USB) flash drives, solid state drives (SSDs), memory cards, smartphones and tablet computing devices, wearable computing devices, industrial robotic devices, and the like. Random access memory (RAM) is a form of computer memory that can be read and changed in any order, and is typically used to store working data and/or machine code. A machine learning (ML) model can be trained for any purpose, and can include an artificial intelligence (AI) model, neural network, or large language model (LLM). These various forms of ML model can be implemented to, for example, perform autonomous robotic tasks, autonomous driving tasks, inference or perception tasks, understand and generate human language, text translation, sentiment analysis, speech recognition, text summarization, language generation, and the like.

### SUMMARY

Described herein is an example SoC comprising both RAM and flash memory for storing respective regions of a machine learning (ML) model, such as an AI model, neural network, or large language model (LLM). An ML model may be trained for any purpose, such as for performing inference operations for autonomous driving, generating text or images, providing text summarization, or performing predictive tasks. As provided herein, model weights of the ML model can comprise numerical parameters that define the internal behavior and decision-making pattern of the ML model, which enable the ML model to learn patterns from real-time data and make predictions and/or decisions. As the model is exposed to more and more training data and learns to map inputs to desired outputs, the weights may be iteratively adjusted (e.g., through optimization techniques). This adjustment of the weights enables the ML model to improve its performance and accuracy over time. In other words, the specific values of the weights of the ML model determine how the model will respond to real-time inputs.

In machine learning, tokens are the smallest units of data processed by the ML model, and typically represent natural language characters, text, words, or images that act as the building blocks for the ML model's input data (e.g., real-time sensor data). As such, tokens comprise individual units of data that are fed into the ML model during training. For image recognition or sensor data processing tasks, each pixel or image segment in an image or each point or collection of points in a point cloud can comprise a token that the ML model uses to identify and classify objects. As provided herein, the weights of the ML model determine how input tokens are transformed as they pass through the layers of the ML model.

As the ML model gets refined through more advanced training and then evaluated, certain areas of the ML model may comprise fixed values and other areas of the ML model may comprise non-fixed values (that are used for dynamic calculations). As the ML model is trained over time and implemented, a monitoring or evaluation tool can be used during a fine-tuning and evaluation phase to measure the statistics of the various weights of the ML model to identify values that are not adjusted or recalculated (i.e., fixed values), which can become candidates for the regions of the ML model to be stored in flash memory. Once the particular values that are fixed of the ML model are determined, then, when the ML model is uploaded to a system-on-chip (SoC), the regions of the ML model having fixed values can be written to the non-volatile memory of the SoC (e.g., flash memory), and the other weights of the ML model can be stored and accessed in volatile memory of the SoC (e.g., RAM or DRAM). In variations, the entire ML model may be stored in non-volatile memory, and during power sequencing, the regions of the ML model having non-fixed values can be loaded to volatile memory (e.g., by a host chiplet of the SoC). As provided herein, the concept of using flash memory for storing fixed value regions of the ML model can be extended to particle filters and other types of algorithms.

In certain implementations, the ML model may be stored in a flash memory chiplet of a SoC comprising an arrangement of chiplets connected by interconnects (e.g., Universal Chiplet Interconnect Express (UCIe) interconnects). During power sequencing, the various regions of the ML model may be activated and a central chiplet can transfer the regions of the ML model required for calculations (e.g., having changing values) from the flash memory chiplet to volatile memory (e.g., DRAM), whereas the regions of the ML model having fixed weights or values may remain in the flash memory chiplet. In various examples, network interface units (NIUs) or other memory controllers of the SoC may be used for remapping memory addresses in which specified regions of the ML model can be routed to specified regions of the volatile memory. In certain implementations, write permission to the non-volatile memory can be restricted by the use of a write permission flag (e.g., 1-bit flag), which can be disabled during normal operation and enabled only when, for example, updating the ML model. It is contemplated that the regions of the ML model stored in the flash memory chiplet will consume significantly less power than the regions of the ML model stored in volatile memory since the non-volatile memory does not require constant refreshing.

For autonomous vehicle operations, it is contemplated that the ML model performing inference tasks (e.g., object detection, object classification, occupancy grid determination, motion planning, vehicle control, vehicle signaling, etc.) can include fixed values for certain aspects of the ML model. For example, while certain aspects of the ML model may be continuously trained or utilized for dynamic calculations, other aspects may be associated with fixed weightings. Described herein is a system-on-chip (SoC) that includes both random access memory (RAM) resources (e.g., dynamic-RAM (DRAM)), and flash memory resources for storing respective regions of an ML model during operation. For example, aspects of the ML model comprising weights or values that are fixed and unchangeable may be stored and accessed in the flash memory chiplet of the SoC. Conversely, aspects of the ML model comprising weights or values that may be recalculated, adjusted, or otherwise utilized for calculations can be stored and accessed in the RAM of the SoC. Accordingly, as the autonomous vehicle's SoC performs inference, motion prediction, motion planning, and vehicle control tasks, the various chiplets can access the respective portions of the ML model in both the flash memory chiplet and DRAM based on the addressing techniques described herein.

It is contemplated that storing regions of the ML model with fixed weightings or values in non-volatile memory provides several advantages to previous implementations, such as increased security, power consumption, cost, bandwidth, and packaging. As an example, the largest LLMs currently in use may comprise trillions of parameters and may consume thousands of mega-watt hours of electricity during training and evaluation. Currently, an example of calculated energy consumption for deploying such an LLM to serve millions of users can amount to gigawatts of electricity, or enough to power over a million households. It is contemplated that the use of non-volatile memory (e.g., flash memory) in storing respective portions or components of an LLM having fixed weights can result in significant power consumption savings.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example system-on-chip (SoC) including a flash memory in which examples described herein may be implemented, according to various examples;

FIG. 2 is another block diagram depicting an example SoC in which examples described herein may be implemented, in accordance with examples described herein;

FIG. 3 depicts a hardware architecture including nodes representing components of a system on chip and links between those components, according to examples described herein;

FIG. 4 is a flow diagram describing an example method of generating a graph based on storage of a ML model in volatile and non-volatile memory, in accordance with examples described herein; and

FIG. 5 is a flow chart describing a method of implementing a machine learning model stored in both random access memory (RAM) and flash memory, according to various examples described herein.

### DETAILED DESCRIPTION

One aspect of the present disclosure relates to a system-on-chip (SoC) having a non-volatile memory on the SoC, or more specifically, a flash memory on the SoC, that stores a machine learning (ML) model, such as a large language model (LLM) or diffusion model. The flash memory can provide a local ML model for the SoC, which may include one or more chiplets that access the ML model to perform inference or other ML operations. In some instances, the SoC may be part of a computing system of an end user, such as a computing system of a vehicle or a mobile phone. The flash memory in these instances allows the vehicle or mobile phone to perform the ML operations locally on the SoC (e.g., for autonomous driving, responding to passenger queries, personalization, etc.), which may reduce reliance on having to access a data center over a network, reduce the time taken to respond to a prompt or process sensor data using a ML model, and offer other benefits.

In some implementations, the SoC stores the ML model in the flash memory (e.g., NAND flash memory or NOR flash memory) instead of faster memory components on the SoC, such as dynamic RAM (DRAM) on the SoC. Although DRAM may exhibit a faster read speed or lower read latency relative to a flash memory, such faster read speeds of DRAM may be more applicable for a data center server attempting to quickly access a ML model to achieve a high bandwidth in terms of accommodating a large number of queries or prompts for a high-throughput web platform. The SoC, on the other hand, may be part of a computing system of a vehicle or other consumer device, in which the read speed exhibited the flash memory may be sufficient for a local ML calculations (e.g., inference operations) that involves the SoC accessing the local ML model. The flash memory may further consume less power than DRAM or other types of memory, which may, for example, improve the battery life of the consumer device (e.g., a smartphone, tablet computer, or wearable computing device).

In some examples, the flash memory is writable, but the SoC may restrict writing to the flash memory, or more specifically control the number of erase/write cycles applied to the flash memory. Such restrictions may reduce degradation of the flash memory (e.g., degradation from electron-induced stress). In some implementations, the SoC includes a bit or flag which controls whether writing to the flash memory is permitted.

In one aspect of this disclosure, chiplets of the SoC may read or otherwise access the ML model directly from the flash memory, rather than load the ML model or a portion thereof into RAM. The flash memory may store the entire ML model, and may have a storage capacity that is large enough to store all the weights (e.g., weights for convolution filters, weights for query, key, and value matrices for the attention heads or softmax layer of a transformer model, etc.) and other parameter values of a ML model (e.g., a storage capacity that is at least hundreds of gigabytes to hundreds of terabytes, or larger storage capacities). Accessing the ML model directly from the flash memory may avoid having to transfer the model or pieces of the model between the flash memory and DRAM of the SoC, which may reduce power consumption and time involved in such transfer.

In some implementations, the SoC may include a bus (e.g., 256-bit or 512-bit bus) for reading the ML model in the flash memory. Such a bus may reduce the need for serializing or de-serializing data (which may occur, e.g., in the context of a PCI bus). In some instances, the SoC may access the flash memory without including a memory controller that would have been needed for serializing and de-serializing data from the flash memory.

In one aspect of this disclosure, the inclusion of flash memory may be especially suitable for a SoC with flash memory, because the chiplets may be easier to communicatively connect with the flash memory, than it is to communicatively connect a CPU with flash memory. For instance, the architecture of the SoC, including the presence of interconnects and network interface units (NIUs) to connect with different modular components, may facilitate the installation of a flash memory within the SoC architecture.

As provided herein, Universal Chiplet Interconnect Express (UCIe) is an open specification for a die-to-die interconnect and serial bus between chiplets. For die-to-die interconnects between chiplets of SoC packages, a high-performance mainband for the transmission of data may be complemented with a high-reliability sideband for transmitting functional safety, clocking, and/or other health monitoring information. A UCIe standardized physical layer, protocol stack, software model, and compliance testing enable users to readily mix and match chiplet components from multiple manufacturers, and further facilitate customized SoC packaging.

In certain implementations, example computing systems described herein, such as systems-on-chip (SoCs), multiple systems-on-chip (mSoCs), or systems-in-package (SIPs) comprising chiplets arrangements can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic. In some examples, a computing “apparatus” can comprise a computing system, such as a system of one or more servers, or an on-board, autonomous vehicle computing system. In variations, a computing apparatus can comprise a computing device, such as computing resources included on a circuit board, personal computer, smartphone computer, tablet computer, laptop, and the like.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

In some embodiments, a computing system implementing the processes described herein can include one or more control circuits that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the control circuit(s) and/or computing system may be part of, or may form, a vehicle control unit (also referred to as a vehicle controller) that is embedded or otherwise disposed in a vehicle (e.g., a Mercedes-Benz® car, truck, or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” may be used herein interchangeably with “and/or”).

In an embodiment, the control circuit(s) may be programmed by one or more computer-readable or computer-executable instructions stored on the non-transitory computer-readable medium. The non-transitory computer-Atty. readable medium may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, for example, a computer diskette, a hard disk drive (HDD), a solid-state drive (SDD) or solid state integrated memory, a random access memory (RAM), a read-only memory (ROM), an erasable programmable read-only memory (EPROM or Flash memory), a static random access memory (SRAM), and/or dynamic random access memory (DRAM). In some cases, the non-transitory computer-readable medium may store computer-executable instructions or computer-readable instructions, such as instructions to perform the methods described throughout the present disclosure.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit to perform one or more functional tasks. The modules and computer-readable/executable instructions may be described as performing various operations or tasks when the control circuit(s) or other hardware components execute the modules or computer-readable instructions.

In further embodiments, the computing system can include a communication interface that enables communications over one or more networks to transmit and receive data. In various examples, the computing system can communicate, over one or more networks, with fleet vehicles using the communication interface to receive sensor data and implement the intersection classification methods described throughout the present disclosure. In certain embodiments, the communication interface may be used to communicate with one or more other systems. The communication interface may include any circuits, components, software, etc. for communicating via one or more networks (e.g., a local area network, wide area network, the Internet, secure network, cellular network, mesh network, and/or peer-to-peer communication link). In some implementations, the communication interface may include for example, one or more of a communications controller, receiver, transceiver, transmitter, port, conductors, software and/or hardware for communicating data/information.

As an example embodiment, the control circuit(s) of the computing system can include a SoC arrangement that facilitates the various methods and techniques described throughout the present disclosure. In various examples, the SoC can include a set of chiplets, including a central chiplet comprising a shared memory in which a reservation table is utilized to execute various autonomous driving workloads, as described herein.

### Example Systems-On-Chip

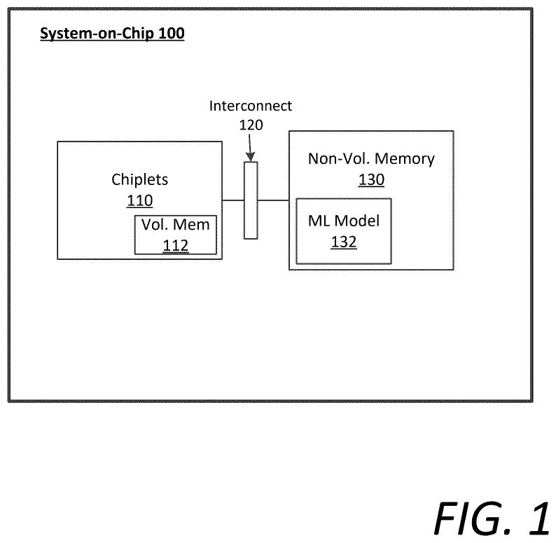

FIG. 1 is a block diagram depicting an example system-on-chip (SoC) 100 including a non-volatile memory component 130 (e.g., flash memory) in which examples described herein may be implemented, according to various examples. In various implementations, the flash memory 130 provides a local ML model 132 for the SoC 100, which may include one or more chiplets 110 that access the ML model 132 via an interconnect 120 to perform inference or other ML operations. In some instances, the SoC 100 may be part of a computing system of an end user, such as a computing system of a vehicle, a mobile phone, or personal computing device. The flash memory 130 in these instances allows the vehicle, mobile phone, or personal computing device to perform the ML operations locally on the SoC 100 (e.g., for autonomous driving, responding to passenger queries, personalization, etc.), which may reduce reliance on having to access a data center over a network, reduce the time taken to respond to a prompt or process sensor data using a ML model 132, and the like.

In some implementations, the SoC 100 stores the ML model 130 in the flash memory 130 (e.g., NAND flash memory or NOR flash memory) instead of faster memory components on the SoC 100, such as dynamic-RAM (DRAM) on the SoC 100. Although DRAM may exhibit a faster read speed and/or lower read latency relative to a flash memory, such faster read speeds of DRAM may be more applicable for a data center server attempting to quickly access a ML model 132 to achieve a high bandwidth in terms of accommodating a large number of queries or prompts for a high-throughput web platform. The SoC 100, on the other hand, may be part of a computing system of a vehicle or consumer device (e.g., smartphone, tablet computer, personal computer, etc.), in which the read speed exhibited the flash memory 130 may be sufficient for a local ML inference operation that involves the SoC 100 accessing the local ML model 132. The flash memory 130 may further consume less power than DRAM or other types of memory, which may, for example, improve the battery life of the consumer device.

In certain implementations, the flash memory 130 may be writeable using a write-permission flag (e.g., a control bit or flag) that controls whether writing to the flash memory 130 is permitted. For example, the SoC 100 may restrict writing to the flash memory 130 or may control the number of erase/write cycles to the flash memory 130 to limit wear. It is contemplated that such restrictions may reduce degradation of the flash memory 130 (e.g., from electron-induced stress).

In certain aspects, the chiplets 110 of the SoC 100 may read or otherwise access the ML model 132 directly from the flash memory 130, rather than load the ML model 132 or a portion thereof into RAM. The flash memory 130 may store the entire ML model 132, and may have a storage capacity that is large enough to store all the weights (e.g., weights for convolution filters, weights for query, key, and value matrices of a transformer model, etc.) and other parameter values of a ML model 132 (e.g., a storage capacity that is at least hundreds of gigabytes to hundreds of terabytes, or larger storage capacities). It is contemplated that accessing the ML model 132 directly from the flash memory 130 may avoid having to transfer the model or pieces of the model between the flash memory 130 and DRAM of the SoC 100, which may reduce power consumption and time involved in such transfer.

In certain implementations, the SoC 100 may include a bus (e.g., 256-bit or 512-bit bus) for reading the ML model 132 in the flash memory 130. Such a bus may reduce the need for serializing or de-serializing data (which may occur, e.g., in the context of a PCI bus). In some instances, the SoC 100 may access the flash memory 130 without including a memory controller that would otherwise be needed for serializing and de-serializing data from the flash memory 130. In one aspect of this disclosure, the inclusion of flash memory 130 may be especially suitable for a SoC 100 with flash memory 130, because the chiplets 110 may more easily connect communicatively with the flash memory 130, as compared to communicatively connecting to a CPU with flash memory 130. For instance, the architecture of the SoC 100, including the presence of interconnects to connect communicatively with different modular components, may facilitate the installation of a flash memory within the SoC 100 architecture.

In various examples, when the SoC 100 is power sequenced, regions of the ML model 132 that comprising non-fixed values can be stored in volatile memory 112 (e.g., RAM) of the chiplets 110, and the regions of the ML model 132 having fixed values can remain in the flash memory 130. Thereafter, inference operations can be performed by the chiplets 110 through execution of the various regions of the ML model 132 with both the RAM 112 and the flash memory 130.

In various examples, the system-on-chip (SoC) 100 can be implemented for vehicle operations, and can include a set of chiplets 110 that includes volatile memory 112, such as a DRAM. The SoC 100 can further include non-volatile memory 130, such as a flash memory chiplet including flash memory adapted to store a machine learning (ML) model 132. In various examples, the flash memory can include a storage capacity of at least 10 GB, and the ML model 132 can include model weights that have been trained. In certain examples, the SoC 100 can include an interconnect 120 to connect the flash memory to the set of chiplets 110.

In certain examples, the set of chiplets 110, when integrated into a vehicle, are adapted to receive an input prompt generated based on vehicle sensor data generated by the vehicle, passenger input from a passenger of the vehicle, or a combination thereof. The set of chiplets 110 also apply the ML model 132 to the input prompt to perform inference by accessing a first set of the model weights of the ML model 132 directly from the flash memory to calculate intermediate values based on the input prompt and the first set of model weights, storing the intermediate values in the DRAM, and accessing a second set of the model weights of the ML model directly from the flash memory to calculate an output of the ML model based on the intermediate values and the second set of model weights. The chiplets 110 may then store the output of the ML model 132 in the DRAM, and generate a vehicle action based on the output of the ML model.

In various examples, the set of chiplets 110 can include a memory controller adapted to map the model weights of the ML model 132 and the intermediate values to a common memory address space. In further examples, the set of chiplets 110 includes a memory controller adapted to set a write-permission flag in a manner that disables write access to the flash memory except when one or more ML models are being loaded to the flash memory.

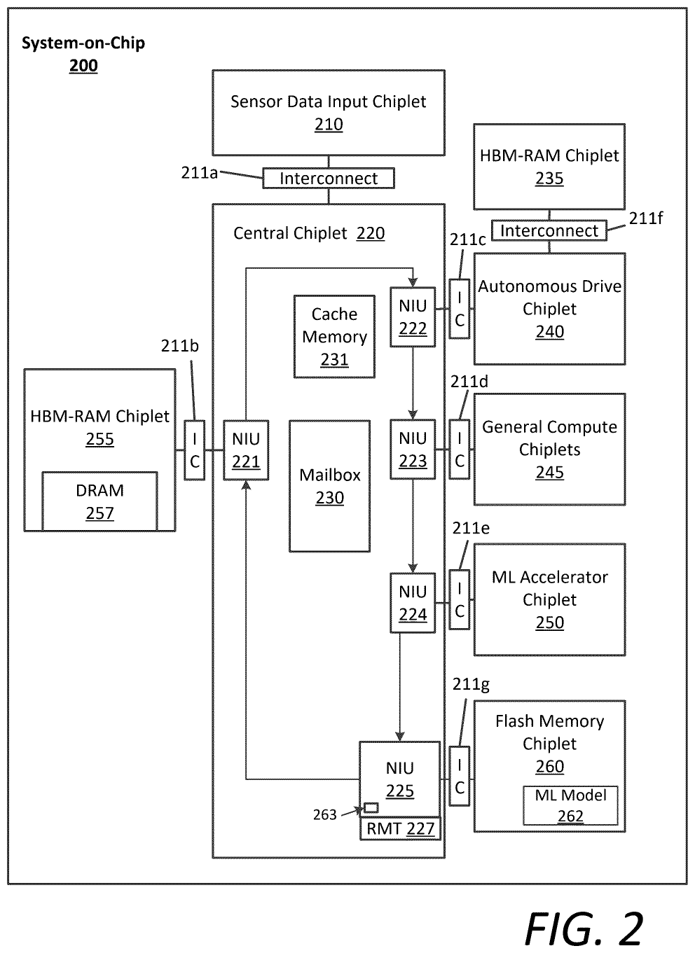

FIG. 2 is a block diagram illustrating an example system-on-chip (SoC) 200, in accordance with examples described herein. The example SoC 200 shown in FIG. 2 can include additional components, and the components of the SoC 200 may be arranged in various alternative configurations other than the example shown. Thus, the SoC 200 of FIG. 2 is described herein as an example arrangement for illustrative purposes and is not intended to limit the scope of the present disclosure in any manner. Furthermore, while the example SoC 200 shown in FIG. 2 may be specified for autonomous vehicle implementations, the SoC 200 may alternatively be configured for general data processing using any type of data. Accordingly, in such alternative implementations, the vehicle sensors 205 shown in FIG. 2 may comprise any data source, and the sensor data input chiplet 210 shown in FIG. 2 may comprise any data input chiplet.

Referring to FIG. 2, as provided herein, the SoC 200 may be part of a vehicle computing system. In such an example, a sensor data input chiplet 210 of the SoC 200 can receive sensor data from various vehicle sensors of the vehicle. These vehicle sensors can include any combination of image sensors (e.g., single cameras, binocular cameras, fisheye lens cameras, etc.), LIDAR sensors, radar sensors, ultrasonic sensors, proximity sensors, and the like. The sensor data input chiplet can automatically dump the received sensor data as it is received into a cache memory 231 of a central chiplet 220. The sensor data input chiplet 210 can also include an image signal processor (ISP) responsible for capturing, processing, and enhancing images taken from the various vehicle sensors.

In some aspects, the sensor data input chiplet 210 publishes identifying information for each item of sensor data (e.g., images, point cloud maps, etc.) to a mailbox 230 of the central chiplet 220, which may act as a central mailbox for synchronizing workloads for the various chiplets of the SoC 200. To communicate with the central chiplet 220, the sensor data input chiplet 210 transmits data through one or more interconnects 211a. Interconnects each represent die-to-die (D2D) interfaces between the chiplets of the SoC 200. In further aspects, the interconnects include high-bandwidth data paths used for general data purposes and a high-reliability data path to transmit functional safety and scheduler information to the shared memory. Network on chip (NoC) and network interface units (NIUs 221, 222, 223, 224, 225) that connect the chiplets can be configured to generate error-correcting code (ECC) data on both the high-bandwidth and high-reliability data paths. Each corresponding NIU on its pairing die has the same ECC configuration, which generates and checks the ECC data to ensure end to end error correction coverage.

Depending on bandwidth requirements, an interconnect 211a-g may include more than one die-to-die interface. For example, interconnect can include two interfaces to support higher bandwidth communications between the sensor data input chiplet 210 and the central chiplet 220. In this example, the interconnects 211a-g and NIUs 221, 222, 223, 224, 225 can communicatively connect the flash memory 260 to other chiplets, such as the central chiplet 220 an ML accelerator chiplet 250, high-bandwidth memory chiplet 255, autonomous drive chiplet 240, general compute chiplets 245, etc., which allows these chiplets to access the ML model 262 stored in the flash memory 260.

In one aspect, the interconnects implement the Universal Chiplet Interconnect Express (UCIe) standard and communicate through an indirect mode to allow each of the chiplet host processors to access remote memory as if it were local memory. This is achieved by using specialized NIUs 221, 222, 223, 224, 225 that provide hardware-level support for remote direct memory access (RDMA) operations. These NIUs also allow for freedom from interference between devices connected to the network. In UCIe indirect mode, the host processor sends requests to a given NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the SoC 200 can include additional chiplets that can store, alter, or otherwise process the sensor data cached by the sensor data input chiplet 210. The SoC 200 can include an autonomous drive chiplet 240 that can perform operations to determine the physical characteristics of the environment around the sensors. These operations can include perception, sensor fusion, trajectory prediction, and/or other autonomous driving algorithms of an autonomous vehicle. To perform these operations, the autonomous drive chiplet 240 can include specialized hardware such as digital signal processors (DSP), a direct memory access (DMA) engine, and neural network (NN) accelerators. The autonomous drive chiplet 240 can be connected to a dedicated HBM-RAM chiplet 235 (e.g., or DRAM component) in which the autonomous drive chiplet 240 can publish all status information, variables, statistical information, and/or processed sensor data as processed by the autonomous drive chiplet 240.

As stated above, the SoC 200 can further include a machine-learning (ML) accelerator chiplet 250 that is specialized for accelerating Artificial Intelligence (AI) workloads, such as image inferences or other sensor inferences using machine learning, in order to achieve high performance and low power consumption for these workloads. The ML accelerator chiplet 250 can include an engine designed to efficiently process graph-based data structures, which are commonly used in AI workloads, and a highly parallel processor, allowing for efficient processing of large volumes of data. The ML accelerator chiplet 250 can also include specialized hardware accelerators for common AI operations such as matrix multiplication and convolution as well as a memory hierarchy designed to optimize memory access for AI workloads, which often have complex memory access patterns. For example, the ML accelerator chiplet 250 may directly read values, weights, and other parameter values of a ML model 262 from the flash memory chiplet 260 and a DRAM component of the SoC 200 (e.g., DRAM 257 located in the HBM-RAM chiplet 255).

In further examples, the general compute chiplets 245 can provide general purpose computing for the SoC 200. For example, the general compute chiplets 245 can comprise high-powered central processing units and/or graphical processing units that can support the computing tasks of the central chiplet 220, autonomous drive chiplet 240, and/or the ML accelerator chiplet 250. In various implementations, the mailbox 230 can store programs and instructions for performing autonomous driving tasks. The mailbox 230 of the central chiplet 220 can further include a reservation table that provides the various chiplets with the information needed (e.g., sensor data items and their locations in memory) for performing their individual tasks.

In various embodiments, one or more chiplets of the SoC 200 (e.g., ML accelerator chiplet 250) may read weights or other parameter values of the ML model 262 directly from the flash memory chiplet 260, and may store intermediate results, such as results of a convolution or scalar multiplication, in DRAM 257 instead of the flash memory chiplet 260 e.g., (so as to reduce the degradation of flash memory 260). In some instances, as stated above, the ML accelerator chiplet 250 may include an engine designed to efficiently process graph-based data structures. In these instances, the SoC 200 may implement an execution graph that uses the ML model 262. The SoC 200 may apply a single instruction, multiple data (SIMD) scheme to enhance the ability to divide the machine learning inference into parallel operations.

In various examples, sensor data input chiplet 210 of the SoC 200 can receive sensor data from various vehicle sensors of the vehicle. These vehicle sensors 205 can include any combination of cameras (e.g., single cameras, binocular cameras, fisheye lens cameras, etc.), LIDAR and radar sensors, ultrasonic sensors, proximity sensors, and the like. As provided herein, the sensor data input chiplet 210 can automatically dump the received sensor data as it is received into a cache memory 231 of the central chiplet 220. The sensor data input chiplet 210 can also include an image signal processor (ISP) responsible for capturing, processing, and enhancing images taken from the various vehicle sensors. The ISP takes the raw image data and performs a series of complex image processing operations, such as color, contrast, and brightness correction, noise reduction, and image enhancement, to create a higher-quality image that is ready for further processing or analysis by the other chiplets of the SoC 200. The ISP may also include features such as auto-focus, image stabilization, and advanced scene recognition to further enhance the quality of the captured images. The ISP can then store the higher-quality images in the cache memory 231.

In some aspects, the sensor data input chiplet 210 publishes identifying information for each item of sensor data (e.g., images, point cloud maps, etc.) to a shared memory 230 of a central chiplet 220, which acts as a central mailbox for synchronizing workloads for the various chiplets. The identifying information can include details such as an address in the cache memory 231 where the data is stored, the type of sensor data, which sensor captured the data, and a timestamp of when the data was captured.

According to embodiments, interconnects 211a-g can each represent chip-to-chip (C2C) or die-to-die (D2D) interfaces between the chiplets of the SoC 200. As provided herein, the interconnects 211a-g can include high-bandwidth data paths used for general data purposes to the cache memory 231 and high-reliability data paths to transmit functional safety (FuSa) and scheduler information to the central chiplet 220. Depending on bandwidth requirements, an interconnect 211a-g may include more than one die-to-die interface.

In one aspect, the interconnects 211a-g implement the Universal Chiplet Interconnect Express (UCIe) standard and communicate through an indirect mode to allow each of the chiplet host processors to access remote memory as if it were local memory. This is achieved by using a specialized Network-on-Chip (NoC) Network Interface Unit (NIU) (e.g., which allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the SoC 200 can include additional chiplets that can store, alter, or otherwise process the sensor data cached by the sensor data input chiplet 210. The SoC 200 can include an autonomous drive chiplet 240 that can perform the perception, sensor fusion, trajectory prediction, and/or other autonomous driving algorithms of the autonomous vehicle. The autonomous drive chiplet 240 can be connected to a dedicated HBM-RAM chiplet 235 in which the autonomous drive chiplet 240 can publish all status information, variables, statistical information, and/or processed sensor data as processed by the autonomous drive chiplet 240.

As described herein, the system-on-chip 200 can further include a machine-learning (ML) accelerator chiplet 240 that is specialized for accelerating machine-learned or AI workloads, such as image inferences or other sensor inferences using machine learning, in order to achieve high performance and low power consumption for these workloads. The ML accelerator chiplet 240 can include an engine designed to efficiently process graph-based data structures, which are commonly used in AI workloads, and a highly parallel processor, allowing for efficient processing of large volumes of data. The ML accelerator chiplet 240 can also include specialized hardware accelerators for common AI operations such as matrix multiplication and convolution as well as a memory hierarchy designed to optimize memory access for AI workloads, which often have complex memory access patterns.

The general compute chiplets 245 can provide general purpose computing for the system on chip 200. For example, the general compute chiplets 245 can comprise high-powered central processing units and/or graphical processing units that can support the computing tasks of the central chiplet 220, autonomous drive chiplet 240, and/or the ML accelerator chiplet 250.

In various implementations, the mailbox 230 can store programs and instructions for performing autonomous driving tasks. The mailbox 230 of the central chiplet 220 can further include a reservation table that provides the various chiplets with the information needed (e.g., sensor data items and their locations in memory) for performing their individual tasks. In various aspects, the central chiplet 220 also includes the large cache memory 231, which supports invalidate and flush operations for stored data.

As provided herein, the mailbox 230 can comprise an architecture in which a reflex program comprising a suite of instructions is used to execute workloads by the central chiplet 220, general compute chiplets 245, and/or autonomous drive chiplet 240. In certain examples, the central chiplet 220 can further execute a FuSa program that operates to compare and verify outputs of respective pipelines to ensure consistency in the ML inference operations. In still further examples, the central chiplet 220 can execute a thermal management program to ensure that the various components of the SoC 200 operate within normal temperature ranges.

Cache miss and evictions from the cache memory 231 can be sent by a high-bandwidth memory (HBM) RAM chiplet 255 connected to the central chiplet 220. The HBM-RAM chiplet 255 can include status information, variables, statistical information, and/or sensor data for all other chiplets. In certain examples, the information stored in the HBM-RAM chiplet 255 can be stored for a predetermined period of time (e.g., ten seconds) before deleting or otherwise flushing the data. For example, when a fault occurs on the autonomous vehicle, the information stored in the HBM-RAM chiplet 255 can include all information necessary to diagnose and resolve the fault. Cache memory 231 can keep fresh data available with low latency and less power required compared to accessing data from the HBM-RAM chiplet 255.

As provided herein, the SoC 200 can include a flash memory chiplet 260 that stores an ML model 262 for performing inference tasks for tasks such as sensor data processing, object detection and classification, occupancy grid processing, motion prediction, motion planning, sensor data encoding/decoding tasks, scene understanding, scene reconstruction (e.g., neural radiance field reconstruction), vehicle control tasks, and the like. When the SoC 200 is power sequenced (e.g., when an autonomous vehicle housing the SoC 200 is started or powered up), the central chiplet 220 can read a set of values of the ML model 262 and apply the set of values to input data (e.g., sensor data from the sensor data input chiplet 210. The central chiplet 220 may then determine regions of the ML model 262 having fixed values and regions of the ML model having non-fixed values.

As provided herein, the regions of the ML model 262 having non-fixed values can comprise regions requiring intermediate calculations (e.g., matrix multiplication results) by applying the weights of the ML model 262 to the input data. These intermediate calculations, or regions of the ML model 262 that include the intermediate calculations, can be stored in a volatile memory component of the SoC 200 (e.g., DRAM 257 of the HBM-RAM chiplet 255 or a RAM in the central chiplet 220). It is contemplated that these regions of the ML model 262 may require write access and therefore are more optimally stored in volatile memory.

As further provided herein, the regions of the ML model 262 having fixed values (or fixed weights) can be stored in the non-volatile memory (e.g., the flash memory chiplet 260 of the SoC 200). It is contemplated that non-volatile memory provides significant advantages in terms of power consumption, storage capacity, and cost at the expense of limited write-access. Accordingly, the regions of the ML model 262 that do not require write access (e.g., those have fixed values or weights) can remain in the non-volatile memory, or flash memory chiplet 260.

As described herein, the SoC 200 can include a set of NIUs 221, 222, 223, 224, 225 that communicatively connect the various chiplets of the SoC 200 to each other via the interconnects 211a-g. In various examples, the flash memory chiplet 260 can connect to and NIU 225 via interconnect 211g. During power sequencing of the SoC 200, the central chiplet 220 can access the ML model 262 via NIU 225, and as described herein, can store non-fixed value regions of the ML model 262 in the DRAM 257 of the HBM-RAM chiplet 255 or other RAM of the SoC 200. In certain examples, the NIU 225 can convert a graph corresponding to the ML model 262 into a set of route mapping tables 227 that control data flow through the SoC 200 based on the regions of the ML model 262 stored in the flash memory chiplet 260 and the regions of the ML model 262 stored in the DRAM 257. For example, regions of the ML model 262 that operate on input data requiring read access only can be maintained in the flash memory chiplet 260, whereas regions of the ML model 262 that operate on input data requiring intermediate calculations and write access can be stored in the DRAM 257 (or other RAM of the SoC 200). The route mapping tables 227 of the NIU 225 can further intercept write access requests to the flash memory chiplet 260, refuse and rename those requests, and send the request and the required data for the write access to a different address (e.g., in DRAM 257).

In various examples, the NIU 225 can maintain an access bit flag 263 or other control mechanism that prevents write access to the flash memory chiplet 260. When this access bit flag 263 is flipped (e.g., by the central chiplet 220 triggered by a ML model update), the NIU 225 enables write access to the flash memory chiplet 260 accordingly.

In certain implementations, the NIUs 221, 222, 223, 224, 225 are adapted to facilitate communication within the SoC 200. In further implementations, the NIU 225 converts a graph corresponding to the ML model 262 into a set of routing tables 227 that control data flow through the SoC 200 based on the regions of the ML model 262 stored in the flash memory chiplet 260 and the regions of the ML model 262 stored in the DRAM 257 (or other RAM of the SoC 200). For example, the NIU 225 can be provided with remapping address space within the DRAM 257 and mailbox 230 with capacity to remap specified regions of the ML model 262 in real time. As such, the NIU 225 can process writing requests into the flash memory chiplet 260 and map them to volatile memory on the SoC 200 (e.g., the DRAM 257).

In various examples, the chiplets of the SoC 200 execute the ML model 262 stored in both the flash memory chiplet 260 and the DRAM 257 on real-time input data using the set of route mapping tables 227.

The real-time input data can comprise sensor data from one or more sensors of an autonomous vehicle in which the SoC 200 operates, and the various chiplets of the SoC 200 execute the ML model 262 stored in the flash memory chiplet 260 and DRAM 257 on the sensor data to autonomously operate the vehicle. In such implementations, the central chiplet 220 can obtain the real-time input data from the sensor data input chiplet 210, and can include a mailbox 230 for addressing and routing the real-time input data based at least in part on the route mapping table 227 of the NIU 225.

In some embodiments, the ML model 262 can comprise a large language model (LLM), and the real-time input data can comprise data representative of at least a portion of one or more prompt inputs from one or more users or sensor data from one or more sensors. For example, the SoC 200 can be included in a datacenter comprising any number of servers and/or SoCs for processing LLM prompt data. The LLM can include regions having fixed values or weights and regions having non-fixed values or weights, and can be dispersed or otherwise stored between non-volatile and volatile memory accordingly. For example, each SoC of the datacenter can store regions of the LLM having fixed values in flash memory, and regions of the LLM having non-fixed values in RAM. Write access to the flash memory can be controlled in the manner described herein (e.g., using a NIU and remapping route tables).

In still further examples, the SoC 200 can be included in a consumer device, such as a smartphone, tablet computer, wearable device, laptop, or other personal computer. In such examples, the ML model 262 can also be stored partially in RAM and partially in flash memory, as described herein. In particular, the regions of the ML model 262 having fixed values can be stored in flash memory and the region of the ML model 1262 having non-fixed values can be stored in RAM when the device is operating.

### Hardware Architecture

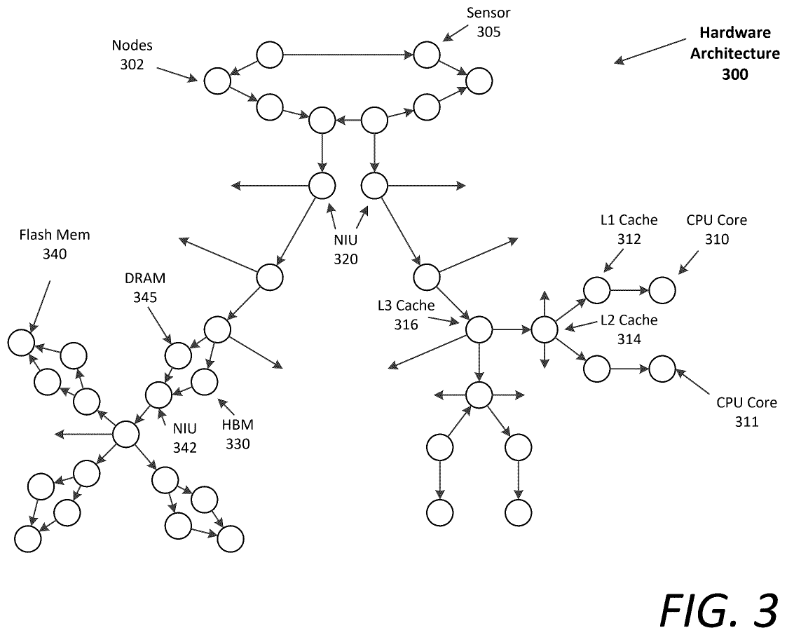

FIG. 3 depicts an example hardware architecture 300 including nodes representing components of a system-on-chip and links between those components. The hardware architecture 300 shown in FIG. 3 can correspond to the arrangement of the plurality of sensors, the plurality of processing components, the set of memory storage locations, and a plurality of network interface units (NIUs).

In one aspect, the graph representation of the hardware architecture 300 can be stored in, at least partially, the network interface units in the form of a data file, such as a YAML file, which is a human-readable data serialization format, or any file capable of representing a graph. The data file can include entries with unique identifiers for each of the nodes 302, such as sensors 305, NIUs 320, High-Bandwidth Memories 330, CPU cores 310, 311, and caches including an L1 cache 312, L2 cache 314, and L3 cache 316. The data file can also include entries for each of the links in the graph, with each link entry specifying a source node, a target node, and a latency value for the link between those nodes. In some examples, the links between nodes 302 represent buses or paths through a network on chip, and the latencies can represent data transport times between the links.

In some aspects, latency values can be measured or simulated values. For example, initial latency values can be taken from technical specifications or determined empirically through a testing process. During operation of the SoC 200, actual latency values can be measured for the links, and the hardware architecture 300 and the graph representation can be updated with the newly measured latency values. Further, the network-on-chip may reroute data through the SoC 200 based on updated optimizations using the measured latency values, thus affecting where sensor data and other data is stored within the SoC 200.

As shown in the SoC hardware architecture 300 of FIG. 3, the SoC 200 can include a flash memory node 340 that represents the flash memory chiplet 260 of FIG. 2. As provided herein, the ML model 262 can be stored in the flash memory node 340, and upon powering up the SoC 200, the respective portions of the ML model 262 having non-fixed values can be stored in a DRAM node 345 of the hardware architecture 300. In some examples, the DRAM can be located in a high-bandwidth memory component of the SoC 200. Alternatively, the regions of the ML model 262 having non-fixed values can be stored in volatile memory of the central chiplet 220.

According to examples, the NIU node 342 can be adapted to control access to the flash memory node 340, and therefore can intercept write requests to the flash memory node 340. As described herein, the NIU node 342 can include a route mapping table based on the regions of the ML model 262 that are stored in the flash memory node 340 and the regions of the ML model 262 that are stored in the DRAM node 345. The route mapping table can direct the flow of data from the sensor nodes 305 throughout the hardware architecture 300 of the SoC 200.

### Methodology

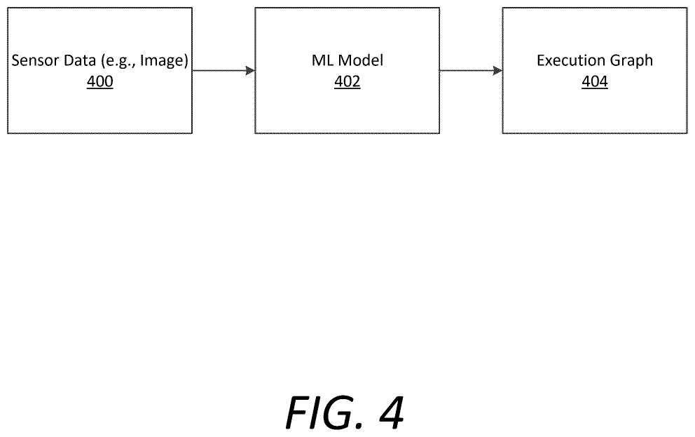

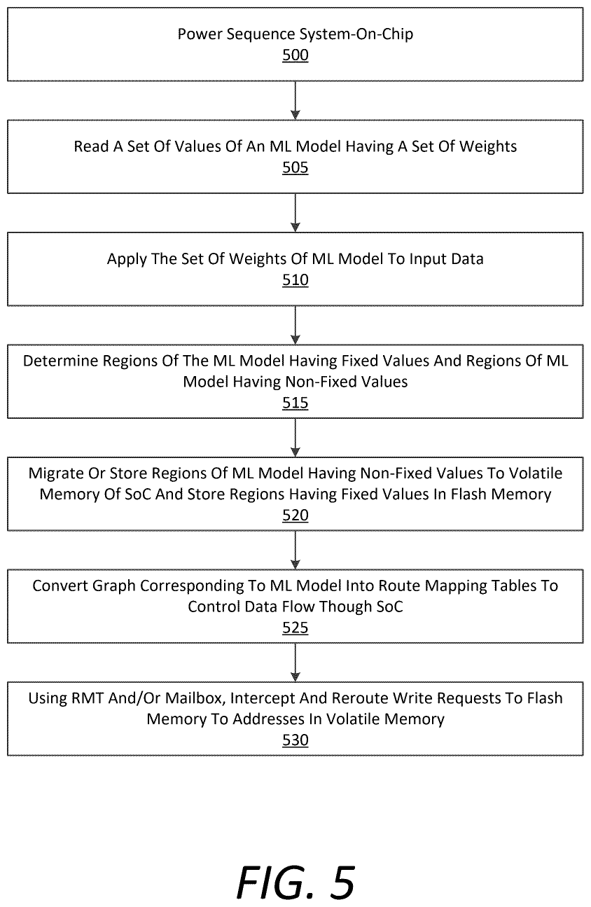

In the below discussion of FIGS. 4 and 5, reference may be made to reference characters representing like features as shown and described with respect to FIGS. 1 through 3. Furthermore, any step described in connection to FIGS. 4 and 5 may be performed prior to, in conjunction with, or subsequent to any other step where suitable. In various examples, the steps can be performed by an example SoC 100, 200 as shown and described with respect to FIGS. 1 and 2.

FIG. 4 is a flow diagram describing an example method of generating a graph based on storage of a ML model in volatile and non-volatile memory, in accordance with examples described herein. Referring to FIG. 4, a SoC 100 may obtain sensor data (e.g., image data) from a set of sensors, at block 400. At block 402, the various weights of an ML model can be applied to the sensor data to determine intermediate calculations, such as matrix multiplication results or consequences of tokens applied to a neural network corresponding to the ML model. At block 404, based on determining the intermediate calculations, the SoC 100 can generate an execution graph based on regions of the ML model that have fixed values and regions requiring intermediate calculations. Thereafter, the SoC 100 can implement the execution graph using the ML model, in which regions of the ML model having non-fixed values (e.g., those requiring intermediate calculations) are stored in volatile memory, and regions of the ML model having fixed values are stored in non-volatile memory of the SoC 100.

FIG. 5 is a flow chart describing a method of implementing a machine learning model stored in both random access memory (RAM) and flash memory, according to various examples described herein. Referring to FIG. 5, a system-on-chip 200 may be power sequenced, at block 500. At block 505, a central chiplet 220 of the SoC 20 can read a set of values of an ML model 262 having a set of weights. As provided herein, the ML model 262 may be stored in non-volatile memory of the SoC 200 (e.g., in a flash memory chiplet 260). At block 510, the central chiplet 220 can receive input data (e.g., sensor data), and apply the set of weights of the ML model 262 to the input data. Upon doing so, at block 515, the central chiplet 220 can determine regions of the ML model 262 having fixed values (e.g., not requiring intermediate calculations), and regions of the ML model 262 having fixed values.

In various examples described herein, at block 520, the central chiplet 220 can migrate or otherwise store the regions of the ML model 262 having non-fixed values to volatile memory of the SoC 200 (e.g., DRAM 257 of an HBM-RAM chiplet 255. The remaining regions of the ML model 262 can be stored in the non-volatile memory (e.g., the flash memory chiplet 260). In certain examples, a NIU 225 that communicatively couples the various chiplets of the SoC 200 to the flash memory chiplet 260 can convert a graph corresponding to the ML model 262 into a route mapping table 227 to control data flow through the SoC 200, at block 525. Accordingly, this route mapping table 227 can correspond to the regions of the ML model 262 stored in the volatile memory (e.g., DRAM 257) and the regions stored in the non-volatile memory (e.g., flash memory chiplet 260).

Using the route mapping table 227 and/or mailbox 230, at block 530, the NIU 225 can intercept and reroute write requests intended for the non-Atty. volatile memory (e.g., flash memory chiplet 260) to addresses in volatile memory (e.g., DRAM 257). In further examples, the NIU 225 can include an access control, such as a bit flag 263, which can prevent write access to the non-volatile memory. This access control or bit flag can be flipped when, for example, and update to the ML model 262 is required.

The execution of the ML model 262 on input data using this approach can provide several advantages to previous implementations. As described herein, such advantages can include increased security, lower cost, bandwidth advantages, and packaging advantages. It is also contemplated that the use of non-volatile memory (e.g., flash memory) in storing respective portions or components of machine learning model (e.g., an LLM) having fixed values can result in significant power consumption savings.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A system-on-chip comprising:
a set of chiplets that includes volatile memory;
a non-volatile memory storing a machine learning (ML) model; and
an interconnect to connect the non-volatile memory to the set of chiplets;
wherein at least one chiplet of the set of chiplet is adapted to:
read a set of values of the ML model;
apply the set of values of the ML model to input data;
based on applying the set of values to the input data, determine regions of the ML model having fixed values and regions of the ML model having non-fixed values; and
migrate or store the regions of the ML model having non-fixed values in the volatile memory of the set of chiplets.

2. The system-on-chip of claim 1, wherein the non-volatile memory comprises a flash memory chiplet of the system-on-chip, and wherein the at least one chiplet stores the regions of the ML model having fixed values in the flash memory chiplet.

3. The system-on-chip of claim 1, wherein the volatile memory comprises a dynamic random-access-memory (DRAM) in a high-bandwidth memory chiplet of the system-on-chip.

4. The system-on-chip of claim 1, wherein the set of chiplets comprises one or more network interface units adapted to facilitate communications within the system-on-chip, and wherein the one or more network interface units convert a graph corresponding to the ML model into a set of routing tables that control data flow through the SoC based on the regions of the ML model stored in the non-volatile memory and the regions of the ML model stored in the volatile memory.

5. The system-on-chip of claim 4, wherein the one or more network interface units use the set of routing tables to remap address space in the volatile memory for the regions of the ML model having non-fixed values.

6. The system-on-chip of claim 5, wherein the one or more network interface units further use the set of routing table to reroute and remap write requests to the non-volatile memory to the volatile memory.

7. The system-on-chip of claim 4, wherein the set of chiplets executes the ML model on real-time input data using the set of routing tables.

8. The system-on-chip of claim 7, wherein the real-time input data comprises sensor data from one or more sensors of an autonomous vehicle, and wherein the set of chiplets execute the ML model on the sensor data to autonomously operate the autonomous vehicle.

9. The system-on-chip of claim 7, wherein the ML model comprises a large language model (LLM), and wherein the real-time input data comprises data representative of at least a portion of one or more prompt inputs from one or more users.

10. The system-on-chip of claim 7, wherein the set of chiplets includes a central chiplet comprising a data input chiplet to obtain the real-time input data, a mailbox for addressing and routing the real-time input data, at least one high-bandwidth memory chiplet, one or more general compute chiplets, and a machine learning accelerator chiplet.

11. The system-on-chip of claim 1, wherein the system-on-chip is included in one of a smartphone, tablet computing device, personal computing device, wearable computing device, or a datacenter server.

12. A computing device comprising,
a volatile memory;
a non-volatile memory storing a machine learning (ML) model; and
one or more processers adapted to:
read a set of values of the ML model;
apply the set of values of the ML model to input data;
based on applying the set of values to the input data, determine regions of the ML model having fixed values and regions of the ML model having non-fixed values; and
migrate or store the regions of the ML model having non-fixed values in the volatile memory of the computing device.

13. The computing device of claim 12, wherein the non-volatile memory comprises a flash memory component, and wherein the one or more processors are adapted to store the regions of the ML model having fixed values in the flash memory component.

14. The computing device of claim 12, wherein the volatile memory comprises a dynamic random-access-memory (DRAM) of the computing device.

15. The computing device of claim 1, further comprising:
one or more network interface units adapted to (i) facilitate communications within the computing device, and (ii) convert a graph corresponding to the ML model into a set of routing tables that control data flow through the computing device based on the regions of the ML model stored in the non-volatile memory and the regions of the ML model stored in the volatile memory.

16. The computing device of claim 15, wherein the one or more network interface units use the set of routing tables to remap address space in the volatile memory for the regions of the ML model having non-fixed values.

17. The computing device of claim 16, wherein the one or more network interface units further use the set of routing table to reroute and remap write requests to the non-volatile memory to the volatile memory.

18. A system-on-chip (SoC) for vehicle operations, comprising:
a set of chiplets that includes DRAM;
a flash memory chiplet having flash memory adapted to store a machine learning (ML) model, the flash memory having a storage capacity of at least 10 GB, the ML model including model weights that have been trained; and
an interconnect to connect the flash memory to the set of chiplets;
wherein the set of chiplets, when integrated into a vehicle, are adapted to
receive an input prompt generated based on vehicle sensor data generated by the vehicle, passenger input from a passenger of the vehicle, or a combination thereof;
apply the ML model to the input prompt to perform inference by:
accessing a first set of the model weights of the ML model directly from the flash memory to calculate intermediate values based on the input prompt and the first set of model weights;
storing the intermediate values in the DRAM;
accessing a second set of the model weights of the ML model directly from the flash memory to calculate an output of the ML model based on the intermediate values and the second set of model weights;
storing the output of the ML model in the DRAM; and
generate a vehicle action based on the output of the ML model.

19. The SoC of claim 18, wherein the set of chiplets include a memory controller adapted to map the model weights of the ML model and the intermediate values to a common memory address space.

20. The SoC of claim 19, wherein the set of chiplets includes a memory controller adapted to set a write-permission flag in a manner that disables write access to the flash memory except when one or more ML models are being loaded to the flash memory.
